(19) United States
(12) Patent Application Publication
(10) Pub. No.: US 2025/0330942 A1
(43) Pub. Date: Oct. 23, 2025

(54) MEASUREMENT METHOD AND COMMUNICATION DEVICE

(71) Applicant: SPREADTRUM SEMICONDUCTOR (NANJING) CO., LTD., Nanjing, Jiangsu (CN)

(72) Inventors: Zhenzhu LEI, Nanjing, Jiangsu (CN); Huayu ZHOU, Nanjing, Jiangsu (CN)

(21) Appl. No.: 18/870,619

(22) PCT Filed: Jun. 1, 2023
(86) PCT No.: PCT/CN2023/097900

§ 371 Date: Nov. 29, 2024

(30) Foreign Application Priority Data
Jun. 1, 2022 (CN) 202210619278.1

(51) Int. Cl. H04W 64/00; H04W 72/0446; H04W 72/231; H04W 74/0833

(52) U.S. Cl. CPC H04W 64/00; H04W 72/0446; H04W 72/231; H04W 74/0833

(57) ABSTRACT

A measurement method and a communication device are disclosed in the disclosure. The method includes: receiving downlink control information (DCI), and determining a location of a global navigation satellite system (GNSS) measurement gap at least according to a time-domain resource location of the DCI, where the DCI is used to trigger a random access procedure or the DCI is used to schedule data; or determining the location of the GNSS measurement gap at least according to a time-domain resource location of data, where the DCI is used to schedule the data, and where the GNSS measurement gap is used for GNSS measurement.

### CROSS-REFERENCE TO RELATED APPLICATION(S)

This application is a National Stage of International Application No. PCT/CN2023/097900, filed Jun. 1, 2023, which claims priority to Chinese Patent Application No. 202210619278.1, filed Jun. 1, 2022, both of which are incorporated herein by reference herein.

### TECHNICAL FIELD

This disclosure relates to the field of satellite communication technology, in particular to a measurement method and a communication device.

### BACKGROUND

In the satellite Internet of things (IoT) system, the orbital altitude of the satellite ranges from hundreds to tens of thousands of kilometers. Because the satellite moves rapidly relative to the terminal device, there is a very large Doppler shift between the terminal device and the satellite and between the satellite and the base station, and the propagation delay between the terminal device and the base station will also change rapidly. In the satellite (IoT) system, the first condition for data transmission is that the terminal device obtains its own location information, so uplink and downlink time-frequency synchronization can be maintained.

The terminal device can obtain its own location information through global navigation satellite system (GNSS) measurement. Therefore, how to determine the location of GNSS measurement gap has become a technical problem to be solved.

### SUMMARY

Embodiments of the disclosure provide a measurement method. The method includes: receiving downlink control information (DCI); and determining a location of a global navigation satellite system (GNSS) measurement gap at least according to a time-domain resource location of the DCI, where the DCI is used to trigger a random access procedure or the DCI is used to schedule data; or determining the location of the GNSS measurement gap at least according to a time-domain resource location of data, where the DCI is used to schedule the data; where the GNSS measurement gap is used for GNSS measurement.

Embodiments of the disclosure provide another measurement method. The method includes: transmitting first indication information, where the first indication information indicates a time offset; and transmitting downlink control information (DCI), where the time offset is a duration between a global navigation satellite system (GNSS) measurement gap and a time-domain resource of the DCI, and the DCI is used to trigger a random access procedure or the DCI is used to schedule data; or the time offset is a duration between the GNSS measurement gap and a time-domain resource of data and the DCI is used to schedule the data; and the GNSS measurement gap is used for GNSS measurement.

Embodiments of the disclosure provide a communication device. The communication device includes a transceiver, a memory, and a processor. The memory stores computer programs. The processor is coupled with the memory and the transceiver and is configured to invoke the computer programs to: cause the transceiver to receive downlink control information (DCI); and determine a location of a global navigation satellite system (GNSS) measurement gap at least according to a time-domain resource location of the DCI, where the DCI is used to trigger a random access procedure or the DCI is used to schedule data; or determine the location of the GNSS measurement gap at least according to a time-domain resource location of data, where the DCI is used to schedule the data, where the GNSS measurement gap is used for GNSS measurement.

### BRIEF DESCRIPTION OF THE DRAWINGS

FIG. 1 is a schematic architecture diagram of a communication system provided in embodiments of the disclosure.

FIG. 2 is a schematic flow chart of a measurement method provided in embodiments of the disclosure.

FIG. 3 is a timing diagram of a global navigation satellite system (GNSS) measurement gap provided in embodiments of the disclosure.

FIG. 4 is another timing diagram of a GNSS measurement gap provided in embodiments of the disclosure.

FIG. 5 is a schematic diagram of a scenario of whether to perform GNSS measurement provided in embodiments of the disclosure.

FIG. 6 is a timing diagram of data transmission provided in embodiments of the disclosure.

FIG. 7 is another timing diagram of data transmission provided in embodiments of the disclosure.

FIG. 8 is a schematic structural diagram of a communication device provided in embodiments of the disclosure.

FIG. 9 is another schematic structural diagram of a communication device provided in embodiments of the disclosure.

FIG. 10 is a schematic structural diagram of a chip module provided in embodiments of the disclosure.

### DETAILED DESCRIPTION

It should be understood that the terms “first”, “second”, and the like referred to in embodiments of the disclosure are used to distinguish different objects, but are not used to describe a specific order. “At least one” in the embodiments of the disclosure refers to one or more, and “multiple” refers to two or more. “And/or” in embodiments of the disclosure describes the association relationship of the association objects, and indicates that there may be three kinds of relationships, for example, A and/or B, which may indicate the following three situations: only A exists, both A and B exist, and only B exists. A and B may be singular or plural. The character “/” can indicate that the associated object before and after is an “or” relationship. In addition, the character “/” may represent a division sign, that is, a division operation is performed.

“At least one of the following items” or similar expressions thereof in the embodiments of the disclosure refer to any combination of these items, including any combination of single items or plural items. For example, at least one of a, b or c may represent the following seven cases: a, b, c, a and b, a and c, b and c, and a, b, and c. Each of a, b, c may be an element or a set containing one or more elements.

In the embodiments of the disclosure, the terms “of”, “relevant”, “corresponding”, “associated”, and “mapped” may be replaced with each other in some cases. It should be pointed out that when not for distinction, the concepts or meanings to be expressed are consistent.

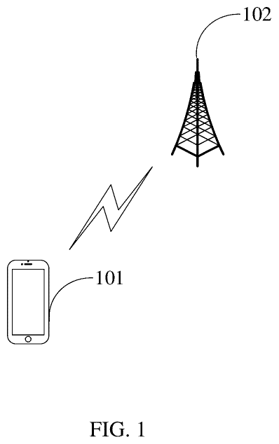

Referring to FIG. 1, FIG. 1 is a schematic architecture diagram of a communication system provided in embodiments of the disclosure. The communication system may include, but is not limited to, one terminal device and one network device. The number and form of devices shown in FIG. 1 are not limited to embodiments of the disclosure. The communication system may include two or more network devices and two or more terminal devices in practical application. The communication system shown in FIG. 1 includes a terminal device 101 and a network device 102 as an example.

The terminal device in embodiments of the disclosure is a device having a wireless transceiver function, and may be referred to as a terminal, a user equipment (UE), a mobile station (MS), a mobile terminal (MT), an access terminal device, an Internet of things (IoT) terminal device, a vehicle terminal device, an industrial control terminal device, a UE unit, a UE station, a mobile radio station, a remote station, a remote terminal device, a mobile device, a UE terminal device, a wireless communication device, a UE agent, or a UE device. The terminal device may be fixed or mobile. The terminal device may support at least one wireless communication technology such as long time evolution (LTE), new radio (NR), wideband code division multiple access (WCDMA), and the like. For example, the terminal device may be a mobile phone, a tablet computer, a desktop computer, a notebook computer, an all-in-one device, a vehicle terminal, a virtual reality (VR) terminal device, or an augmented reality (AR) terminal device, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, a cellular phone, a cordless phone, a session initiation protocol (SIP) telephone, a wireless local loop (WLL) station, a personal digital assistants (PDA), a handheld device or computing device with wireless communication capability, or other processing device connected to a wireless modem, a wearable device, a terminal device in a future mobile communication network, or a terminal device in a future evolved public land mobile network (PLMN), etc. In some embodiments of the disclosure, the terminal device may also be a device having a transceiver function, such as a chip module. The chip module may include a chip and may also include other discrete devices. The embodiments of the disclosure do not limit the specific technology and the specific device form adopted by the terminal device.

In embodiments of the disclosure, the network device is a device that provides a wireless communication function for the terminal device, the network device may be an access network (AN) device or a satellite, and the AN device may be a radio access network (RAN) device. The access network device may support at least one wireless communication technology, such as LTE, NR, WCDMA, etc. For example, the access network device includes, but is not limited to, a next generation base station (gNB), an evolved node B (eNB), a radio network controller (RNC), a node B (NB), a base station controller (BSC), a base transceiver station (BTS), a home base station (e.g., home evolved node B, or home node B (HNB)), a baseband unit (BBU), a TRP, a transmitting point (TP), a mobile switching center, or the like in 5th-generation (5G). The network device may also be a wireless controller, a centralized unit (CU), and/or a distributed unit (DU) in a cloud radio access network (CRAN) scenario, or the access network device may be a relay station, an access point, a vehicle-mounted device, a terminal device, a wearable device, an access network device in a future mobile communication or an access network device in a future evolved PLMN, or the like. In some embodiments, the network device may also be a device, such as a chip module, having a wireless communication function for the terminal device. For example, the chip module may include a chip and may also include other discrete devices. The embodiments of the disclosure do not limit the specific technology and the specific device form adopted by the network device.

It should be noted that the technical solutions of the embodiments of the disclosure can be applied to various communication systems, for example, non-terrestrial networks (NTN) (i.e., satellite communication), 5G mobile communication systems, and 5G NR systems. Optionally, the method of embodiments of the disclosure is also applicable to various future communication systems, such as a 6G system or other communication networks.

It can be understood that the communication system described in embodiments of the disclosure is to more clearly explain the technical solution of embodiments of the disclosure, and does not constitute a limitation on the technical solution provided in embodiments of the disclosure. Those skilled in the art can know that with the evolution of the system architecture and the emergence of new business scenarios, the technical solution provided in embodiments of the disclosure is equally applicable to similar technical problems.

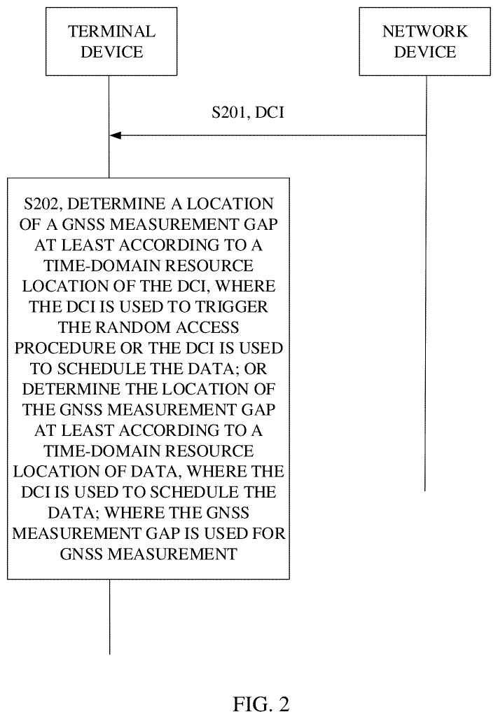

FIG. 2 is a schematic flow chart of a measurement method provided in embodiments of the disclosure. As shown in FIG. 2, the measurement method may include, but is not limited to, the following steps.

S201, a network device transmits downlink control information (DCI). Accordingly, a terminal device receives the DCI.

The network device determines the DCI and then transmits the DCI to the terminal device. The DCI is used to trigger a random access procedure, or the DCI is used to schedule data. The DCI used to trigger the random access procedure may be carried in a physical downlink control channel (PDCCH) Order.

S202, the terminal device determines a location of a global navigation satellite system (GNSS) measurement gap at least according to a time-domain resource location of the DCI, where the DCI is used to trigger the random access procedure or the DCI is used to schedule the data; or the terminal device determines the location of the GNSS measurement gap at least according to a time-domain resource location of data, where the DCI is used to schedule the data; where the GNSS measurement gap is used for GNSS measurement.

The GNSS measurement gap is a time-domain window, and the time-domain window represents a segment of time-domain resources. After receiving the DCI, the terminal device may determine the location of the GNSS measurement gap according to one or more of the following methods. Method 1, if the DCI is used to trigger the random access procedure, the terminal device determines the location of the GNSS measurement gap at least according to the time-domain resource location of the DCI. Method 2, if the DCI is used for scheduling the data, the terminal device determines the location of the GNSS measurement gap at least according to the time-domain resource location of the data. Method 3, if the DCI is used for scheduling the data, the terminal device determines the location of the GNSS measurement gap at least according to the time-domain resource location of the DCI. In embodiments of the disclosure, the time-domain resource location (such as the location of the GNSS measurement gap) may include, but is not limited to, a start location and/or an end location of the time-domain resource.

To be noted that, the terminal device can determine the location of the GNSS measurement gap according to one or a combination of the above three methods. Exemplarily, the combination of Method 1 and Method 2 means that: when the DCI is used to trigger the random access procedure, the terminal device determines the location of the GNSS measurement gap according to Method 1, and when the DCI is used to schedule the data, the terminal device determines the location of the GNSS measurement gap according to Method 2.

In an implementation, the terminal device determines the location of the GNSS measurement gap at least according to the time-domain resource location of the DCI as follows. The terminal device determines the location of the GNSS measurement gap according to the time-domain resource location of the DCI and a time offset, where the time offset is a duration between the GNSS measurement gap and a time-domain resource of the DCI.

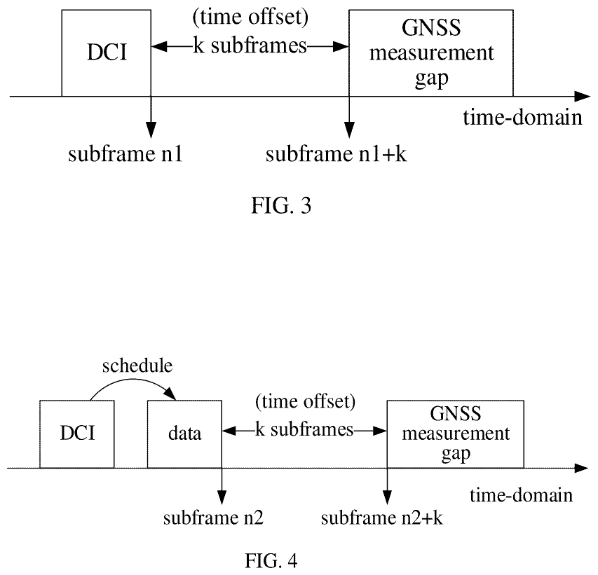

Optionally, the time offset may be a duration between a start location of the GNSS measurement gap and an end location of the time-domain resource of the DCI. In this case, the terminal device may determine the start location of the GNSS measurement gap according to the end location of the time-domain resource of the DCI and the time offset. Exemplarily, the start location of the GNSS measurement gap is a sum of the end location of the time-domain resource of the DCI and the time offset. For example, in the timing diagram of the GNSS measurement gap shown in FIG. 3, the end location of the time-domain resource of the DCI is at subframe n1 and the time offset is k subframes, so the start location of the GNSS measurement gap is at subframe n1+k.

Optionally, the time offset may be a duration between an end location of the GNSS measurement gap and the end location of the time-domain resource of the DCI. In this case, the terminal device may determine the start location and the end location of the GNSS measurement gap according to the end location of the time-domain resource of the DCI, the time offset, and a duration of the GNSS measurement gap. For example, the end location of the GNSS measurement gap is a sum of the end location of the time-domain resource of the DCI and the time offset, and the start location of the GNSS measurement gap is a difference between the end location of the GNSS measurement gap and the duration of the GNSS measurement gap. For example, the end location of the time-domain resource of the DCI is at subframe n1, the time offset is (k+m) subframes, and the duration of the GNSS measurement gap is m subframes, so the end location of the GNSS measurement gap is at subframe n1+ (k+m) and the start location of the GNSS measurement gap is at subframe n1+(k+m)−m=n1+k.

In the above example, the unit of the time offset and the unit of the duration of the GNSS measurement gap being subframes is for illustration. In other implementations, the unit of the time offset and the unit of the duration of the GNSS measurement gap may be milliseconds, seconds, slots, symbols (such as orthogonal frequency division multiplexing (OFDM) symbols), frames, or other units, and the embodiments of the disclosure are not limited thereto.

In an implementation, the terminal device determines the location of the GNSS measurement gap at least according to the time-domain resource location of the data as follows. The terminal device determines the location of the GNSS measurement gap according to the time-domain resource location of the data and a time offset, where the time offset is a duration between the GNSS measurement gap and a time-domain resource of the data.

Optionally, the time offset may be a duration between the start location of the GNSS measurement gap and an end location of the time-domain resource of the data. In this case, the terminal device may determine the start location of the GNSS measurement gap according to the end location of the time-domain resource of the data and the time offset. Exemplarily, the start location of the GNSS measurement gap is a sum of the end location of the time-domain resource of the data and the time offset. For example, in the timing diagram of the GNSS measurement gap shown in FIG. 4, the end location of the time-domain resource of the data scheduled by the DCI is at subframe n2 and the time offset is k subframes, so the start location of the GNSS measurement gap is at subframe n2+k.

Optionally, the time offset may be a duration between the end location of the GNSS measurement gap and the end location of the time-domain resource of the data. In this case, the terminal device may determine the start location and the end location of the GNSS measurement gap according to the end location of the time-domain resource of the data, the time offset, and the duration of the GNSS measurement gap. For example, the end location of the GNSS measurement gap is a sum of the end location of the time-domain resource of the data and the time offset, and the start location of the GNSS measurement gap is a difference between the end location of the GNSS measurement gap and the duration of the GNSS measurement gap. For example, the end location of the time-domain resource of the data scheduled by the DCI is at subframe n2, the time offset is (k+m) subframes, and the duration of the GNSS measurement gap is m subframes, so the end location of the GNSS measurement gap is at subframe n2+(k+m) and the start location of the GNSS measurement gap is at subframe n2+(k+m)−m=n2+k.

In an implementation, the network device may further transmit first indication information, and accordingly, the terminal device may receive the first indication information, where the first indication information is used to indicate the time offset. The network device may transmit the first indication information before transmitting the DCI, and accordingly, the terminal device receives the first indication information before receiving the DCI. The first indication information may be carried in higher layer signaling, system information, or the DCI (i.e., the DCI is also used to indicate the time offset). For example, the higher layer signaling may be radio resource control (RRC) signaling. In another implementation, the time offset may also be predefined in the protocol.

In an implementation, the network device may further transmit second indication information, and accordingly, the terminal device may receive the second indication information, where the second indication information is used to indicate the duration of the GNSS measurement gap. The network device may transmit the second indication information before transmitting the DCI, and accordingly, the terminal device receives the second indication information before receiving the DCI. The second indication information may be carried in higher layer signaling, system information, or the DCI (i.e., the DCI is also used to indicate the duration of the GNSS measurement gap). In another implementation, the duration of the GNSS measurement gap may also be predefined in the protocol.

In an implementation, the DCI may also be used to indicate whether to enable the GNSS measurement gap. The GNSS measurement gap is a time-domain window, and the time-domain window represents a segment of time-domain resources. Enabling the GNSS measurement gap may indicate that the terminal device is allowed to perform GNSS measurement within the time-domain window. Disabling the GNSS measurement gap may indicate that the terminal device is not allowed to perform GNSS measurement within the time-domain window. When the GNSS measurement gap is enabled, the terminal device can perform GNSS measurement within the GNSS measurement gap. It is noted that, when the GNSS measurement gap is enabled, the terminal device may or may not perform GNSS measurement within the GNSS measurement gap, which is not limited in embodiments of the disclosure.

Optionally, the DCI may explicitly or implicitly indicate whether to enable the GNSS measurement gap.

The explicit indication means that the DCI includes an indication field for indicating whether to enable the GNSS measurement gap. Exemplarily, the DCI includes indication information a (i.e., the indication field), indication information a indicates whether to enable the GNSS measurement gap. For example, one bit is set in the DCI to carry indication information a. When a value of the bit corresponding to indication information a is 0, indication information a indicates not to enable the GNSS measurement gap, and when the value of the bit corresponding to indication information a is 1, indication information a indicates to enable to the GNSS measurement gap. The DCI may also be used to schedule the data or the DCI may also be used to trigger the random access procedure.

The implicit indication may mean that a type of DCI has a correspondence (such as correspondence 1) with whether to enable the GNSS measurement gap, and the terminal device may determine whether to enable the GNSS measurement gap according to correspondence 1 after receiving the DCI and decoding. The type of DCI may include, but is not limited to, the DCI for triggering the random access procedure, the DCI for scheduling the data. For example, correspondence 1 includes, for example, a correspondence between the DCI for triggering the random access procedure and enabling the GNSS measurement gap, and a correspondence between the DCI for scheduling the data and enabling the GNSS measurement gap. If the terminal device receives the DCI for triggering the random access procedure, the DCI implicitly indicates to enable the GNSS measurement gap, in other words, when the terminal device receives the DCI for triggering the random access procedure (i.e., PDCCH Order), the GNSS measurement gap is enabled by default. If the terminal device receives the DCI for scheduling the data, the DCI implicitly indicates to enable the GNSS measurement gap. If the DCI received by the terminal device is not used to trigger the random access procedure or not to schedule the data, the DCI may implicitly indicate not to enable the GNSS measurement gap.

Alternatively, the implicit indication may also mean that the DCI includes information (e.g., referred to as information b) having a correspondence (e.g., referred to as correspondence 2) with whether to enable the GNSS measurement gap, and the terminal device may determine whether to enable the GNSS measurement gap according to information b and correspondence 2. Herein, information b can be carried in the original indication field in the DCI, that is, there is no need to expand a new indication field in the DCI to indicate whether to enable the GNSS measurement gap. For example, information b is carried in a format indication field in the DCI, where the format indication field occupies 1 bit, and correspondence 2 includes that: a value of the bit corresponding to the format indication field being 1 corresponds to enabling the GNSS measurement gap, and the value of the bit corresponding to the format indication field being 0 corresponds to disabling the GNSS measurement gap. If the value of the bit corresponding to the format indication field in the DCI received by the terminal device is 1, the DCI implicitly indicates to enable the GNSS measurement gap. If the value of the bit corresponding to the format indication field in the DCI received by the terminal device is 0, the DCI implicitly indicates not to enable the GNSS measurement gap. The DCI may also be used to schedule the data, or the DCI may also be used to trigger the random access procedure.

Optionally, in addition to according to whether to enable the GNSS measurement gap indicated by the DCI, whether the GNSS measurement is performed within the GNSS measurement gap may be determined according to whether a previous GNSS measurement result fails. The previous GNSS measurement is obtained from the most recent GNSS measurement. In an implementation, if the previous GNSS measurement result fails, the terminal device may perform GNSS measurement within the GNSS measurement gap. In other words, if the previous GNSS measurement result fails, the terminal device may determine that the GNSS measurement gap needs to be enabled, and further, the terminal device may perform GNSS measurement within the GNSS measurement gap. It can be understood that if the previous GNSS measurement result is valid, the terminal device may determine that the GNSS measurement gap does not need to be enabled, and accordingly, the terminal device may not perform GNSS measurement.

In an implementation, failure of the previous GNSS measurement result means that a timer corresponding to the previous GNSS measurement result expires. The timer corresponding to the previous GNSS measurement result is started when the previous GNSS measurement result is obtained. The duration of the timer is the valid duration of the previous GNSS measurement result, and the previous GNSS measurement result becomes invalid when the timer expires (or the timing ends). If the timer has not expired (or the timing has not ended), the previous GNSS measurement result is valid. Note that, every time the corresponding GNSS measurement result is generated by performing corresponding GNSS measurement, a corresponding timer may be started.

For example, the valid duration of the previous GNSS measurement result is 3s, when the terminal device completes GNSS measurement and obtains the GNSS measurement result, the timer corresponding to the GNSS measurement result may be started. The timer starts counting down from 3s, and when the timer counts down to 0s, the timer expires, and at this time, the GNSS measurement result becomes invalid. The timer may also be a count-up timer. For example, the valid duration of the previous GNSS measurement result is 3s, when the terminal device completes GNSS measurement and obtains the GNSS measurement result, the timer corresponding to the GNSS measurement result may be started. The timer starts counting from 0s, and when the timer counts up to 3s or more than 3s, the timer expires, and at this time, the GNSS measurement result becomes invalid.

In another implementation, failure of the previous GNSS measurement result means that a cache duration of the previous GNSS measurement result is longer than the valid duration of the previous GNSS measurement result. When the cache duration of the previous GNSS measurement result is less than or equal to the valid duration, the previous GNSS measurement result is valid.

It should be noted that the failure of the previous GNSS measurement result may individually trigger the GNSS measurement within the GNSS measurement gap. In this case, the DCI may not indicate whether to enable the GNSS measurement gap. In other words, whether to perform the GNSS measurement within the GNSS measurement gap may only refer to whether the previous GNSS measurement result is invalid, but not refer to the indication content of the DCI or the DCI may not indicate whether to enable the GNSS measurement gap. For example, upon the terminal device completes GNSS measurement within the GNSS measurement gap, the timer is started, and the terminal device does not need to start the GNSS measurement gap to perform GNSS measurement before the timer expires (i.e., when the previous GNSS measurement result is valid). When the timer expires (i.e., the previous GNSS measurement result fails), the terminal device can enable the GNSS measurement gap and perform GNSS measurement within the GNSS measurement gap.

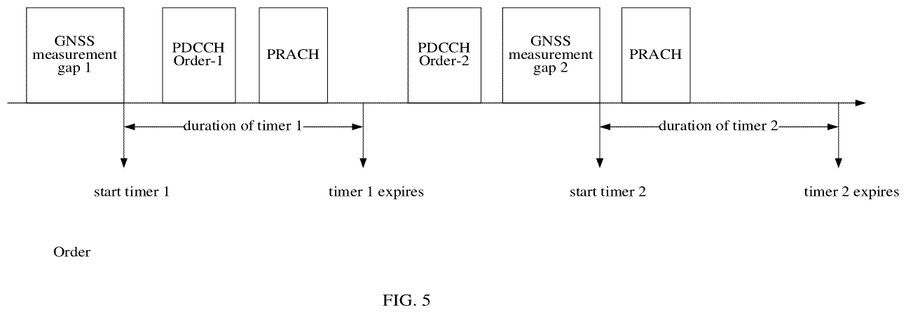

Alternatively, the terminal device may consider both the indication content of the DCI and whether the previous GNSS measurement result fails, to determine whether to perform the GNSS measurement within the GNSS measurement gap. In this case, whether to perform GNSS measurement within the GNSS measurement gap needs to refer to whether the previous GNSS measurement result fails and the indication content of the DCI. For example, on condition that the DCI indicates (implicitly or explicitly) to enable the GNSS measurement gap and the previous GNSS measurement result fails, the terminal device may perform GNSS measurement within the GNSS measurement gap. On condition that the DCI indicates (implicitly or explicitly) to enable the GNSS measurement gap and the previous GNSS measurement result is valid, the terminal device may not perform GNSS measurement. For example, the GNSS measurement gap is enabled by default when the terminal device receives the PDCCH Order (that is, the DCI is used to implicitly indicate to enable the GNSS measurement gap), and a schematic diagram of whether to perform GNSS measurement is shown in FIG. 5, where the PDCCH Order is also used to trigger the random access procedure. Referring to FIG. 5, upon the terminal device completes GNSS measurement within GNSS measurement gap 1, timer 1 is started, and GNSS measurement result 1 is obtained by performing GNSS measurement, where a duration of timer 1 is a valid duration of GNSS measurement result 1. When the terminal device receives PDCCH Order-1 before timer 1 expires (that is, when GNSS measurement result 1 is valid), the terminal device determines that the GNSS measurement gap does not need to be enabled to perform GNSS measurement, and transmits the physical random access channel (PRACH) after receiving PDCCH Order-1. When the terminal device receives PDCCH Order-2 after timer 1 expires (that is, when GNSS measurement result 1 is invalid), the terminal device determines that GNSS measurement gap 2 needs to be enabled to perform GNSS measurement. Upon the terminal device completes GNSS measurement within GNSS measurement gap 2, new timer 2 is started, and the terminal device transmits the PRACH after completing GNSS measurement. Timer 1 and timer 2 are the same in duration.

Alternatively, in the example corresponding to FIG. 5, 1 bit may be configured in the PDCCH Order to carry indication information a (not shown in FIG. 5), and indication information a is used to explicitly indicate whether to enable the GNSS measurement gap. When the value of the bit corresponding to indication information a is 0, indication information a indicates not to enable the GNSS measurement gap, and when the value of the bit corresponding to indication information a is 1, indication information a indicates to enable the GNSS measurement gap. For example, the value of the bit corresponding to indication information a in each of PDCCH Order-1 and PDCCH Order-2 is 1. As shown in FIG. 5, when the terminal device receives PDCCH Order-1 before timer 1 expires, the terminal device determines that it is not necessary to start the GNSS measurement gap to perform GNSS measurement, and transmits the PRACH after receiving PDCCH Order-1. When the terminal device receives PDCCH Order-2 after timer 1 expires, the terminal device determines that it is necessary to start GNSS measurement gap 2 to perform GNSS measurement, and upon the terminal device completes GNSS measurement within GNSS measurement gap 2, new timer 2 is started, and the terminal device transmits the PRACH after completing GNSS measurement.

In this way, it is advantageous to avoid performing GNSS measurement frequently, thereby saving resources and prolonging the battery life of the terminal device. The IoT terminal devices have relatively high requirements on the battery life, if GNSS measurement is performed frequently, the battery life of the device will be seriously shortened.

In an implementation, when it is determined in the above manner that the GNSS measurement gap is not enabled or the GNSS measurement is not performed, the terminal device may perform the following steps. If the DCI is used to trigger the random access procedure, the terminal device may transmit the PRACH. If the DCI is used for scheduling the data, the terminal device may determine a time-frequency resource for transmitting the data according to the indication in the DCI and transmit the data on the time-frequency resource. The terminal device transmits the PRACH, which means that the terminal device transmits a random access request on the PRACH. The terminal device transmits the data, which means that the terminal device transmits uplink data or receives downlink data according to the scheduling information in the DCI. For example, the terminal device transmits uplink data on a physical uplink shared channel (PUSCH), or the terminal device receives downlink data on a physical downlink shared channel (PDSCH).

In an implementation, the network device may further transmit third indication information, and accordingly, the terminal device may receive the third indication information, where the third indication information is used to indicate a duration of the timer. The network device may transmit the third indication information before transmitting the DCI, and accordingly, the terminal device receives the third indication information before receiving the DCI. The third indication information may be carried in higher layer signaling, system information, or the DCI (i.e., the DCI is also used to indicate the duration of the timer). Optionally, the third indication information may occupy one bit or more bits. Taking the third indication information occupying one bit as an example, the value of the bit being 1 may indicate to enable the GNSS measurement gap, and the value of the bit being 0 may indicate not to enable the GNSS measurement gap. In another implementation, the duration of the timer may also be predefined in the protocol. Optionally, the valid duration of the previous GNSS measurement result may be indicated by the network device or may be predefined in the protocol, which is not limited in embodiments of the disclosure.

In an implementation, the network device may determine the duration of the timer according to the following method. The terminal device reports timing reference indication information, where the timing reference indication information indicates a reference valid duration of the GNSS measurement result. Accordingly, the network device receives the timing reference indication information and determines the duration of the timer according to the reference valid duration. Optionally, the reference valid duration may be determined according to the capability of the terminal device and/or the mobility information of the terminal device. For example, if the battery capacity of the terminal device is large, the reference valid duration may be shorter. If the location of the terminal device can remain fixed for a longer period of time, the reference valid duration may be longer. If the location of the terminal device remains fixed for a shorter period of time, the reference valid duration may be shorter. Optionally, the network device may determine the reference valid duration reported by the terminal device as the duration of the timer, or the network device may determine a sum of the reference valid duration reported by the terminal device and a preset duration as the duration of the timer, where the preset duration may be agreed in the protocol.

Optionally, the units of the duration of the timer and the valid duration of the previous GNSS measurement result may be milliseconds, seconds, slots, symbols, frames, or other units, which are not limited in the embodiments of the disclosure.

In an implementation, when the DCI is used to trigger the random access procedure, the terminal device may transmit the PRACH after completing the GNSS measurement within the GNSS measurement gap. In other words, when the DCI is used to trigger the random access procedure, the terminal device initiates the random access procedure after completing GNSS measurement within the GNSS measurement gap, that is, the location of the GNSS measurement gap is prior to a time-domain resource location of the PRACH. The terminal device can obtain the location information of the terminal device after completing GNSS measurement within the GNSS measurement gap. The location information of the terminal device can be used to calculate a timing advance (TA) amount. By accurately calculating the TA amount, it is beneficial to improve the probability that the terminal device transmits the PRACH and successfully accesses the network.

In an implementation, when DCI is used to schedule the data, the location of the GNSS measurement gap may be prior to the time-domain resource location of the data, or the time-domain resource location of the data may be prior to the location of the GNSS measurement gap. In other words, when DCI is used to schedule the data, the timing of transmitting the data by the terminal device may be: performing GNSS measurement within the GNSS measurement gap and then transmitting the data, or transmitting the data and then performing GNSS measurement within the GNSS measurement gap. “The location of the GNSS measurement gap is prior to the time-domain resource location of the data” means that the terminal device first performs GNSS measurement within the GNSS measurement gap and then transmits the data. “The time-domain resource location of the data is prior to the location of the GNSS measurement gap” means that the terminal device first transmits the data and then performs GNSS measurement within the GNSS measurement gap.

The GNSS measurement gap is one time-domain resource. In embodiments of the disclosure, the relative locational relationship of two time-domain resources (such as the GNSS measurement gap and the time-domain resource of the data) may be determined according to time units occupied by time-domain resources. The time unit may be, for example, a frame, a subframe, a slot, a symbol, or other unit in the time-domain, and embodiments of the disclosure is not limited. Taking the time unit as a symbol as an example, the relative relationship of the location of the GNSS measurement gap and the time-domain resource location of the data can be determined according to the first symbol or the last symbol occupied by each of the two time-domain resources.

For example, if the symbol index of the first symbol occupied by the GNSS measurement gap is less than the symbol index of the first symbol occupied by the time-domain resource of the data, the location of the GNSS measurement gap is considered to be ahead of the time-domain resource location of the data. Alternatively, if the symbol index of the last symbol occupied by the GNSS measurement gap is less than the symbol index of the first symbol occupied by the time-domain resource of the data, the location of the GNSS measurement gap is considered to be ahead of the time-domain resource location of the data. Alternatively, if the symbol index of the last symbol occupied by the GNSS measurement gap is less than the symbol index of the last symbol occupied by the time-domain resource of the data, the location of the GNSS measurement gap is considered to be ahead of the time-domain resource location of the data. A symbol index of a certain symbol is used to characterize the index location of the symbol. It should be noted that for two symbols (such as symbol 1 and symbol 2), the symbol index of symbol 1 being smaller than the symbol index of symbol 2 can also be described as: symbol 1 being earlier than symbol 2.

In an implementation, the time unit occupied by the GNSS measurement gap and the time unit occupied by the time-domain resource of the data do not overlap in the time-domain, in other words, the GNSS measurement and data transmission are time-divided, and the terminal device does not simultaneously perform GNSS measurement and data transmission. By separating data transmission and GNSS measurement in time, the terminal device can perform GNSS measurement even in a service scenario where the terminal device performs long-term data transmission, so that accurate location information of the terminal device can be obtained without interrupting data transmission. For IoT terminal devices, the time-divided GNSS measurement and data transmission can reduce the complexity of the IoT terminal devices.

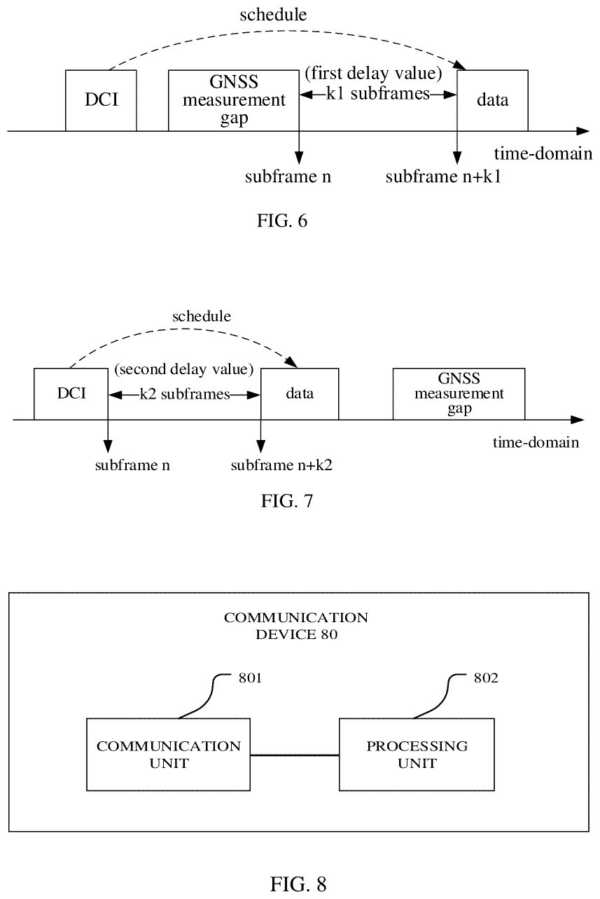

In an implementation, when the terminal device first performs GNSS measurement within the GNSS measurement gap and then transmits the data, the start location of the time-domain resource of the data may rely on the end location of the GNSS measurement gap and a first delay value, where the first delay value is a delay between the start location of the time-domain resource of the data and the end location of the GNSS measurement gap. Optionally, the start location of the time-domain resource of the data is a sum of the end location of the GNSS measurement gap and the first delay value. For example, as shown in FIG. 6, if the end location of the GNSS measurement gap is at subframe n and the first delay value is k1 subframes, the start location of the time-domain resource of the data scheduled by the DCI is at subframe n+k1.

When the terminal device first transmits the data and then performs GNSS measurement within the GNSS measurement gap, the start location of the time-domain resource of the data may reply on the end location of the time-domain resource of the DCI and a second delay value, where the second delay value is a delay between the start location of the time-domain resource of the data and the end location of the time-domain resource of the DCI. Optionally, the start location of the time-domain resource of the data is a sum of the end location of the time-domain resource of the DCI and the second delay value. For example, as illustrated in FIG. 7, when the end location of the time-domain resource of the DCI is at subframe n and the second delay value is k2 subframes, the start location of the time-domain resource of the data scheduled by the DCI is at subframe n+k2.

It should be noted that the location of the GNSS measurement gap in FIG. 6 can be determined according to the time-domain resource location of the DCI and the time offset, and the time offset is the duration between the GNSS measurement gap and the time-domain resource of the DCI. For details, reference is made to the above description, which will not be repeated herein. The location of the GNSS measurement gap in FIG. 7 can be determined according to the time-domain resource location of the data scheduled by the DCI and the time offset, and the time offset is the duration between the GNSS measurement gap and the time-domain resource of the data. For details, reference is made to the above description, which will not be repeated herein.

Optionally, both the first delay value and the second delay value may be indicated through the DCI, or may be indicated through fourth indication information transmitted by the network device, or may be predefined in the protocol. The fourth indication information may be carried in higher layer signaling or system information.

Optionally, the first indication information, the second indication information, the third indication information, and the fourth indication information may be carried in the same signaling or message, or may be carried in different signaling or messages. For example, when the first indication information, the second indication information, the third indication information, and the fourth indication information are carried in the same signaling or message, the duration of the GNSS measurement gap, the time offset, and the duration of the timer may be indicated using the same bit information or different bit information.

In an implementation, the terminal device may perform GNSS measurement while in an RRC_Connected state. For example, when the terminal device is in the RRC_Connected state, the terminal device may receive the DCI for triggering the random access procedure. Then, while the terminal device is still in the RRC_Connected state, the terminal device initiates the random access procedure after performing GNSS measurement within the GNSS measurement gap and obtaining the location information of the terminal device. For another example, while the terminal device is in the RRC_Connected state, the terminal device may receive the DCI for scheduling the data. While the terminal device is still in the RRC_Connected state, the terminal device first performs GNSS measurement within the GNSS measurement gap to obtain the location information of the terminal device, and then performs data transmission. Alternatively, while the terminal device is still in the RRC_Connected state, the terminal device first performs data transmission, and then performs GNSS measurement within the GNSS measurement gap to obtain the location information of the terminal device.

Compared with the method in which GNSS measurement can be performed only in a RRC_Idle state, by performing GNSS measurement in the RRC_Connected state, the terminal device can better adapt to more scenarios. For example, if the terminal device can only perform GNSS measurement in the RRC_Idle state, the terminal device cannot support a long-term data transmission service scenario. Because the terminal device first needs to exit the RRC_Connected state and then enter the RRC_Idle state to perform GNSS measurement, the terminal device cannot support long-term data transmission services. In embodiments of the disclosure, the terminal device supports performing GNSS measurement in the RRC_Connected state, which can support long-term data transmission services. In addition, through the time division of data transmission and GNSS measurement, the data transmission and GNSS measurement will not interfere with each other, and the complexity of the terminal device can be reduced.

In embodiments of the disclosure, the terminal device determines the location of the GNSS measurement gap according to the time-domain resource location of the DCI or the time-domain resource location of the data scheduled by the DCI. In the first aspect, the location of the GNSS measurement gap can be flexibly determined. In the second aspect, the terminal device supports performing GNSS measurement during the RRC_Connected state, so that the terminal device can support long-term data transmission services. In the third aspect, through the time division of data transmission and GNSS measurement, the data transmission and GNSS measurement will not interfere with each other, and the complexity of the terminal device can be reduced.

Referring to FIG. 8, FIG. 8 is a schematic structural diagram of a communication device provided in embodiments of the disclosure. As shown in FIG. 8, the communication device 80 includes a communication unit 801 and a processing unit 802. The communication device 80 may perform the related steps of the terminal device and the network device in the above-described method embodiments.

In the case where the communication device 80 is used to implement the function of the terminal device in the above-described embodiment, the communication unit 801 is configured to receive downlink control information (DCI); and the processing unit 802 is configured to: determine a location of a global navigation satellite system (GNSS) measurement gap at least according to a time-domain resource location of the DCI, where the DCI is used to trigger a random access procedure or the DCI is used to schedule data; or determine the location of the GNSS measurement gap at least according to a time-domain resource location of data, where the DCI is used to schedule the data, where the GNSS measurement gap is used for GNSS measurement.

In an optional implementation, in terms of determining the location of the GNSS measurement gap at least according to the time-domain resource location of the DCI, the processing unit 802 is configured to determine the location of the GNSS measurement gap according to the time-domain resource location of the DCI and a time offset, where the time offset is a duration between the GNSS measurement gap and a time-domain resource of the DCI.

In an optional implementation, in terms of determining the location of the GNSS measurement gap at least according to the time-domain resource location of the data, the processing unit 802 is configured to determine the location of the GNSS measurement gap according to the time-domain resource location of the data and a time offset, where the time offset is a duration between the GNSS measurement gap and a time-domain resource of the data.

In an optional implementation, the communication unit 801 is further configured to receive first indication information, where the first indication information indicates the time offset.

In an optional implementation, the communication unit 801 is further configured to receive second indication information, where the second indication information indicates a duration of the GNSS measurement gap.

In an optional implementation, the DCI further indicates to enable the GNSS measurement gap.

In an optional implementation, the processing unit 802 is further configured to perform GNSS measurement within the GNSS measurement gap.

In an optional implementation, the processing unit 802 is further configured to perform GNSS measurement within the GNSS measurement gap if a previous GNSS measurement result fails, where the previous GNSS measurement result is obtained from the most recent GNSS measurement.

In an optional implementation, failure of the previous GNSS measurement result includes that: a timer corresponding to the previous GNSS measurement result expires.

In an optional implementation, the communication unit 801 is further configured to receive third indication information, where the third indication information indicates a duration of the timer.

In an optional implementation, the communication unit 801 is further configured to transmit timing reference indication information, where the timing reference indication information indicates a reference valid duration of a GNSS measurement result.

In an optional implementation, after performing GNSS measurement within the GNSS measurement gap, the communication unit 801 is further configured to transmit a physical random access channel (PRACH), where the DCI is used to trigger the random access procedure.

In an optional implementation, the location of the GNSS measurement gap is prior to the time-domain resource location of the data, or the time-domain resource location of the data is prior to the location of the GNSS measurement gap.

In an optional implementation, a start location of a time-domain resource of the data relies on an end location of the GNSS measurement gap and a first delay value, where the first delay value is a delay of the start location of the time-domain resource of the data relative to the end location of the GNSS measurement gap; or the start location of the time-domain resource of the data relies on an end location of a time-domain resource of the DCI and a second delay value, where the second delay value is a delay of the start location of the time-domain resource of the data to the end location of the time-domain resource of the DCI.

Specifically, in this case, the operation performed by the communication unit 801 and the processing unit 802 may refer to the description of the terminal device in the embodiment corresponding to FIG. 2 described above.

In an implementation, in the case where the communication device 80 is used to implement the function of the network device in the above-described embodiment, the communication unit 801 is configured to transmit first indication information, where the first indication information indicates a time offset; and the communication unit 801 is further configured to transmit downlink control information (DCI), where the time offset is a duration between a global navigation satellite system (GNSS) measurement gap and a time-domain resource of the DCI, and the DCI is used to trigger a random access procedure or the DCI is used to schedule data; or the time offset is a duration between the GNSS measurement gap and a time-domain resource of data and the DCI is used to schedule the data; and the GNSS measurement gap is used for GNSS measurement.

In an optional implementation, the communication unit 801 is further configured to transmit second indication information, where the second indication information indicates a duration of the GNSS measurement gap.

In an optional implementation, the DCI further indicates to enable the GNSS measurement gap.

In an optional implementation, the communication unit 801 is further configured to transmit third indication information, where the third indication information indicates a duration of a timer corresponding to a GNSS measurement result.

In an optional implementation, the communication unit 801 is further configured to receive timing reference indication information, where the timing reference indication information indicates a reference valid duration of the GNSS measurement result; and the processing unit 802 is configured to determine the duration of the timer according to the reference valid duration.

In an optional implementation, a location of the GNSS measurement gap is prior to a time-domain resource location of the data, or the time-domain resource location of the data is prior to the location of the GNSS measurement gap.

In an optional implementation, a start location of the time-domain resource of the data relies on an end location of the GNSS measurement gap and a first delay value, where the first delay value is a delay of the start location of the time-domain resource of the data relative to the end location of the GNSS measurement gap; or the start location of the time-domain resource of the data relies on an end location of the time-domain resource of the DCI and a second delay value, where the second delay value is a delay of the start location of the time-domain resource of the data to the end location of the time-domain resource of the DCI.

Specifically, in this case, the operation performed by the communication unit 801 and the processing unit 802 may refer to the description of the network device in the embodiment corresponding to FIG. 2 described above.

In another implementation, in the case where the communication device 80 is used to implement the function of the network device in the above embodiment, the processing unit 802 is configured to determine downlink control information (DCI); and the communication unit 801 is configured to transmit the DCI, where the DCI is used to trigger a random access procedure or the DCI is used to schedule data; where the DCI is further used to indicate to enable a global navigation satellite system (GNSS) measurement gap, and the GNSS measurement gap is used for GNSS measurement.

In an optional implementation, the communication unit 801 is further configured to transmit first indication information, where the first indication information indicates a time offset, where the time offset is a duration between the GNSS measurement gap and a time-domain resource of the DCI, and the DCI is used to trigger a random access procedure or the DCI is used to schedule the data; or the time offset is a duration between the GNSS measurement gap and a time-domain resource of the data and the DCI is used to schedule the data.

In an optional implementation, the communication unit 801 is further configured to transmit second indication information, where the second indication information indicates a duration of the GNSS measurement gap.

In an optional implementation, the communication unit 801 is further configured to transmit third indication information, where the third indication information indicates a duration of a timer corresponding to a GNSS measurement result.

In an optional implementation, the communication unit 801 is further configured to receive timing reference indication information, where the timing reference indication information indicates a reference valid duration of the GNSS measurement result; and the processing unit 802 is further configured to determine the duration of the timer according to the reference valid duration.

In an optional implementation, a location of the GNSS measurement gap is prior to a time-domain resource location of the data, or the time-domain resource location of the data is prior to the location of the GNSS measurement gap.

In an optional implementation, a start location of a time-domain resource of the data relies on an end location of the GNSS measurement gap and a first delay value, where the first delay value is a delay of the start location of the time-domain resource of the data relative to the end location of the GNSS measurement gap; or the start location of the time-domain resource of the data relies on an end location of a time-domain resource of the DCI and a second delay value, where the second delay value is a delay of the start location of the time-domain resource of the data to the end location of the time-domain resource of the DCI.

Specifically, in this case, the operation performed by the communication unit 801 and the processing unit 802 may refer to the description of the network device in the embodiment corresponding to FIG. 2 described above.

The communication device 80 may also be used to implement other functions of the terminal device and the network device in the embodiment corresponding to FIG. 2, which will not be repeatedly described herein. Based on the same inventive concept, the principles for solving problems and beneficial effects of the communication device 80 provided in the embodiments of the disclosure are similar to the principles for solving problems and beneficial effects of the terminal device and the network device in the method embodiments of the disclosure. Reference can be made to the principles and beneficial effects of the method embodiments, which will not be repeated here for the sake of concise description.

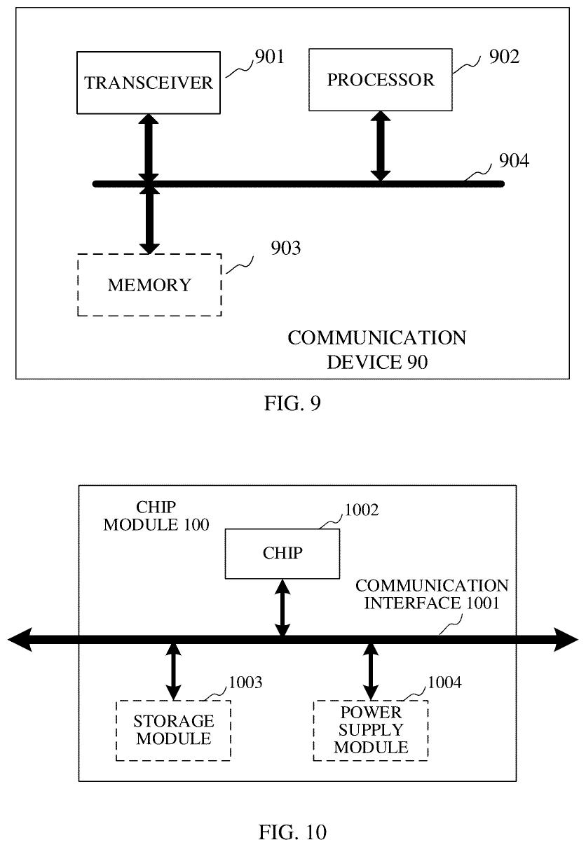

Referring to FIG. 9, FIG. 9 is another communication device 90 provided in embodiments of the disclosure. The communication device 90 is configured to implement the function of the terminal device in the above-described method embodiments, or to implement the function of the network device in the above-described method embodiments. The communication device 90 may include a transceiver 901 and a processor 902. Optionally, the communication device may further include a memory 903. The transceiver 901, the processor 902, and the memory 903 may be connected by a bus 904 or other means. The bus is shown with a thick line in FIG. 9, and the connection mode between other components is only schematic and is not limited. The bus can include address bus, data bus, control bus, etc. For ease of representation, only one thick line is shown in FIG. 9, but it does not indicate that there is only one bus or one type of bus.

The coupling in the embodiments of the disclosure is an indirect coupling or communication connection between devices, units or modules, and may be in an electrical, mechanical or other form for information interaction between devices, units or modules. The specific connection medium among the transceiver 901, the processor 902, and the memory 903 is not limited in embodiments of the disclosure.

The memory 903 may include read-only memory and random access memory, and provides instructions and data to the processor 902. A portion of the memory 903 may also include a non-volatile random access memory.

The processor 902 may be a central processing unit (CPU), or may be another general purpose processor, a digital signal processor (DSP), an application specific integrated circuit (ASIC), a field-programmable gate array (FPGA) or other programmable logic device, a discrete gate or transistor logic device, a discrete hardware component, or the like. The general-purpose processor may be a microprocessor, and optionally, the processor 902 may be any conventional processor or the like.

In one example, when the terminal device adopts the form shown in FIG. 9, the processor in FIG. 9 may execute the method executed by the terminal device in any of the above method embodiments.

In one example, when the network device adopts the form shown in FIG. 9, the processor in FIG. 9 may execute the method executed by the network device in any of the method embodiments described above.

In an alternative embodiment, memory 903 is configured to store program instructions. The processor 902 is configured to invoke the program instructions stored in the memory 903 to execute the steps executed by the terminal device and the network device in the embodiments corresponding to FIG. 2. Specifically, the function/implementation of the communication unit and the processing unit in FIG. 8 can be realized by the processor 902 in FIG. 9 invoking the computer execution instructions stored in the memory 903. Alternatively, the function/implementation of the processing unit in FIG. 8 may be implemented by the processor 902 in FIG. 9 invoking the computer execution instructions stored in the memory 903, and the function/implementation of the communication unit in FIG. 8 may be implemented by the transceiver 901 in FIG. 9.

In embodiments of the disclosure, the method provided in embodiments of the disclosure may be implemented by running a computer program (including program codes) capable of performing the steps involved in the above-described method on a general-purpose computing device such as a computer including a processing element and a storage element, such as a CPU, a random access memory (RAM), a read-only memory (ROM). The computer program may be described on, for example, a computer-readable recording medium, loaded into the above-described computing device by the computer-readable recording medium, and executed therein.

Based on the same inventive concept, the principles for solving problems and beneficial effects of the communication device 90 provided in the embodiments of the disclosure are similar to the principles for solving problems and beneficial effects of the terminal device and the network device in the method embodiments of the disclosure. Reference can be made to the principles and beneficial effects of the method embodiments, which will not be repeated here for the sake of concise description.

The above communication device (such as the communication device 80 and the communication device 90) may be, for example, a chip or a chip module.

Embodiments of the disclosure also provides a chip. The chip can execute the related steps of the terminal device and the network device in the method embodiments.

In the case where the chip is used to implement the function of the terminal device in the above embodiment, the chip is configured to: receive downlink control information (DCI); and determine a location of a global navigation satellite system (GNSS) measurement gap at least according to a time-domain resource location of the DCI, where the DCI is used to trigger a random access procedure or the DCI is used to schedule data; or determine the location of the GNSS measurement gap at least according to a time-domain resource location of data, where the DCI is used to schedule the data, where the GNSS measurement gap is used for GNSS measurement.

In an optional implementation, in terms of determining the location of the GNSS measurement gap at least according to the time-domain resource location of the DCI, the chip is configured to determine the location of the GNSS measurement gap according to the time-domain resource location of the DCI and a time offset, where the time offset is a duration between the GNSS measurement gap and a time-domain resource of the DCI.

In an optional implementation, in terms of determining the location of the GNSS measurement gap at least according to the time-domain resource location of the data, the chip is configured to determine the location of the GNSS measurement gap according to the time-domain resource location of the data and a time offset, where the time offset is a duration between the GNSS measurement gap and a time-domain resource of the data.

In an optional implementation, the chip is further configured to receive first indication information, where the first indication information indicates the time offset.

In an optional implementation, the chip is further configured to receive second indication information, where the second indication information indicates a duration of the GNSS measurement gap.

In an optional implementation, the DCI further indicates to enable the GNSS measurement gap.

In an optional implementation, the chip is further configured to perform GNSS measurement within the GNSS measurement gap.

In an optional implementation, the chip is further configured to perform GNSS measurement within the GNSS measurement gap if a previous GNSS measurement result fails, where the previous GNSS measurement result is obtained from the most recent GNSS measurement.

In an optional implementation, failure of the previous GNSS measurement result includes that: a timer corresponding to the previous GNSS measurement result expires.

In an optional implementation, the chip is further configured to receive third indication information, where the third indication information indicates a duration of the timer.

In an optional implementation, the chip is further configured to transmit timing reference indication information, where the timing reference indication information indicates a reference valid duration of a GNSS measurement result.

In an optional implementation, after performing GNSS measurement within the GNSS measurement gap, the chip is further configured to transmit a physical random access channel (PRACH), where the DCI is used to trigger the random access procedure.

In an optional implementation, the location of the GNSS measurement gap is prior to the time-domain resource location of the data, or the time-domain resource location of the data is prior to the location of the GNSS measurement gap.

In an optional implementation, a start location of a time-domain resource of the data relies on an end location of the GNSS measurement gap and a first delay value, where the first delay value is a delay of the start location of the time-domain resource of the data relative to the end location of the GNSS measurement gap; or the start location of the time-domain resource of the data relies on an end location of a time-domain resource of the DCI and a second delay value, where the second delay value is a delay of the start location of the time-domain resource of the data to the end location of the time-domain resource of the DCI.

Specifically, in this case, the operation performed by the chip may refer to the description of the terminal device in the embodiment corresponding to FIG. 2.

In an implementation, in the case where the chip is used to implement the function of the network device in the above embodiment, the chip is configured to: transmit first indication information, where the first indication information indicates a time offset; and transmit downlink control information (DCI), where the time offset is a duration between a global navigation satellite system (GNSS) measurement gap and a time-domain resource of the DCI, and the DCI is used to trigger a random access procedure or the DCI is used to schedule data; or the time offset is a duration between the GNSS measurement gap and a time-domain resource of data and the DCI is used to schedule the data; and the GNSS measurement gap is used for GNSS measurement.

In an optional implementation, the chip is further configured to transmit second indication information, where the second indication information indicates a duration of the GNSS measurement gap.

In an optional implementation, the DCI further indicates to enable the GNSS measurement gap.

In an optional implementation, the chip is further configured to transmit third indication information, where the third indication information indicates a duration of a timer corresponding to a GNSS measurement result.

In an optional implementation, the chip is further configured to receive timing reference indication information, where the timing reference indication information indicates a reference valid duration of the GNSS measurement result; and determine the duration of the timer according to the reference valid duration.

In an optional implementation, a location of the GNSS measurement gap is prior to a time-domain resource location of the data, or the time-domain resource location of the data is prior to the location of the GNSS measurement gap.

In an optional implementation, a start location of the time-domain resource of the data relies on an end location of the GNSS measurement gap and a first delay value, where the first delay value is a delay of the start location of the time-domain resource of the data relative to the end location of the GNSS measurement gap; or the start location of the time-domain resource of the data relies on an end location of the time-domain resource of the DCI and a second delay value, where the second delay value is a delay of the start location of the time-domain resource of the data to the end location of the time-domain resource of the DCI.

Specifically, in this case, the operation performed by the chip may refer to the description of the network device in the embodiment corresponding to FIG. 2.

In another implementation, in a case where the chip is used to implement the function of the network device in the above embodiment.

The chip is configured to: determine downlink control information (DCI); and transmit the DCI, where the DCI is used to trigger a random access procedure or the DCI is used to schedule data; where the DCI is further used to indicate to enable a global navigation satellite system (GNSS) measurement gap, and the GNSS measurement gap is used for GNSS measurement.

In an optional implementation, before transmitting the DCI, the chip is further configured to transmit first indication information, where the first indication information indicates a time offset, where the time offset is a duration between the GNSS measurement gap and a time-domain resource of the DCI, and the DCI is used to trigger a random access procedure or the DCI is used to schedule the data; or the time offset is a duration between the GNSS measurement gap and a time-domain resource of the data and the DCI is used to schedule the data.

In an optional implementation, the chip is further configured to transmit second indication information, where the second indication information indicates a duration of the GNSS measurement gap.

In an optional implementation, the chip is further configured to transmit third indication information, where the third indication information indicates a duration of a timer corresponding to a GNSS measurement result.

In an optional implementation, the chip is further configured to receive timing reference indication information, where the timing reference indication information indicates a reference valid duration of the GNSS measurement result; and determine the duration of the timer according to the reference valid duration.

In an optional implementation, a location of the GNSS measurement gap is prior to a time-domain resource location of the data, or the time-domain resource location of the data is prior to the location of the GNSS measurement gap.

In an optional implementation, a start location of a time-domain resource of the data relies on an end location of the GNSS measurement gap and a first delay value, where the first delay value is a delay of the start location of the time-domain resource of the data relative to the end location of the GNSS measurement gap; or the start location of the time-domain resource of the data relies on an end location of a time-domain resource of the DCI and a second delay value, where the second delay value is a delay of the start location of the time-domain resource of the data to the end location of the time-domain resource of the DCI.

Specifically, in this case, the operation performed by the chip may refer to the description of the network device in the embodiment corresponding to FIG. 2.

In one possible implementation, the chip includes at least one processor, at least one first memory, and at least one second memory. The at least one first memory and the at least one processor are interconnected by the line, and instructions are stored in the first memory. The at least one second memory and the at least one processor are interconnected by the line, and the data to be stored in the embodiment of the method is stored in the second memory.

For each device or product applied to or integrated with the chip, each module included in the device may be implemented in hardware such as circuits. Alternatively, at least some modules may be implemented in a software program that runs on a processor integrated within the chip, and the remaining modules (if any) may be implemented in hardware such as circuits.

Based on the same inventive concept, the principles for solving problems and beneficial effects of the chip provided in the embodiments of the disclosure are similar to the principles for solving problems and beneficial effects of the terminal device and the network device in the method embodiments of the disclosure. Reference can be made to the principles and beneficial effects of the method embodiments, which will not be repeated here for the sake of concise description.

Referring to FIG. 10, FIG. 10 is a schematic structural diagram of a chip module provided in embodiments of the disclosure. The chip module 100 may perform the related steps of the terminal device and the network device in the method embodiments described above, and the chip module 100 includes a communication interface 1001 and a chip 1002.

The communication interface is configured for communication within the chip module or for communication between the chip module and an external device. The chip is used to implement the functions of the terminal device and the network device in embodiments of the disclosure, and reference is made to the embodiment corresponding to FIG. 2 for details. Optionally, the chip module 100 may further include a storage module 1003 and a power supply module 1004. The storage module 1003 is used to store data and instructions. The power supply module 1004 is used to supply power for the chip module.

For each device or product applied to or integrated into the chip module, each module included therein may be implemented in hardware such as circuits, where different modules may be located in the same component (e.g., chip, circuit module, etc.) or different components of the chip module. Alternatively, at least some modules may be implemented in a software program that runs on an integrated processor within the chip module, and the remaining (if any) modules can be implemented in hardware such as circuits.

Embodiments of the disclosure also provide a computer-readable storage medium. The computer-readable storage medium stores a computer program, and the computer program includes one or more program instructions. The one or more program instructions are adapted to be loaded by a communication device and execute the method provided in the above-described method embodiments.

Embodiments of the disclosure also provide a computer program product. The computer program product includes a computer program or instructions. When the computer program or instructions are run on the computer, the computer executes the method provided in the above method embodiments.

Embodiments of the disclosure further provides a measurement system, and the system may include the terminal device and the network device in the embodiment corresponding to FIG. 2.

The disclosure discloses a measurement method and a communication device, which is beneficial to flexibly determining a location of a GNSS measurement gap.

According to a first aspect, embodiments of the disclosure provide a measurement method. The method includes: receiving downlink control information (DCI); and determining a location of a global navigation satellite system (GNSS) measurement gap at least according to a time-domain resource location of the DCI, where the DCI is used to trigger a random access procedure or the DCI is used to schedule data; or determining the location of the GNSS measurement gap at least according to a time-domain resource location of data, where the DCI is used to schedule the data; where the GNSS measurement gap is used for GNSS measurement.

In an optional implementation, determining the location of the GNSS measurement gap at least according to the time-domain resource location of the DCI includes: determining the location of the GNSS measurement gap according to the time-domain resource location of the DCI and a time offset, where the time offset is a duration between the GNSS measurement gap and a time-domain resource of the DCI.

In an optional implementation, determining the location of the GNSS measurement gap at least according to the time-domain resource location of the data includes: determining the location of the GNSS measurement gap according to the time-domain resource location of the data and a time offset, where the time offset is a duration between the GNSS measurement gap and a time-domain resource of the data.

In an optional implementation, before receiving the DCI, the method further includes: receiving first indication information, where the first indication information indicates the time offset.

In an optional implementation, the method further includes: receiving second indication information, where the second indication information indicates a duration of the GNSS measurement gap.

In an optional implementation, the DCI further indicates to enable the GNSS measurement gap.

In an optional implementation, the method further includes: performing GNSS measurement within the GNSS measurement gap.

In an optional implementation, the method further includes: performing GNSS measurement within the GNSS measurement gap if a previous GNSS measurement result fails, where the previous GNSS measurement result is obtained from the most recent GNSS measurement.

In the technical solution, it is beneficial to avoid performing GNSS measurement frequently, thereby saving resources and prolonging the battery life of the terminal device.

In an optional implementation, failure of the previous GNSS measurement result includes that: a timer corresponding to the previous GNSS measurement result expires.

In an optional implementation, the method further includes: receiving third indication information, where the third indication information indicates a duration of the timer.

In an optional implementation, the method further includes: transmitting timing reference indication information, where the timing reference indication information indicates a reference valid duration of a GNSS measurement result.

In an optional implementation, after performing GNSS measurement within the GNSS measurement gap, the method further includes: transmitting a physical random access channel (PRACH), where the DCI is used to trigger the random access procedure.

In an optional implementation, the location of the GNSS measurement gap is prior to the time-domain resource location of the data, or the time-domain resource location of the data is prior to the location of the GNSS measurement gap.

In an optional implementation, a start location of a time-domain resource of the data relies on an end location of the GNSS measurement gap and a first delay value, where the first delay value is a delay of the start location of the time-domain resource of the data relative to the end location of the GNSS measurement gap; or the start location of the time-domain resource of the data relies on an end location of a time-domain resource of the DCI and a second delay value, where the second delay value is a delay of the start location of the time-domain resource of the data to the end location of the time-domain resource of the DCI.

According to a second aspect, embodiments of the disclosure provide another measurement method. The method includes: transmitting first indication information, where the first indication information indicates a time offset; and transmitting downlink control information (DCI), where the time offset is a duration between a global navigation satellite system (GNSS) measurement gap and a time-domain resource of the DCI, and the DCI is used to trigger a random access procedure or the DCI is used to schedule data; or the time offset is a duration between the GNSS measurement gap and a time-domain resource of data and the DCI is used to schedule the data; and the GNSS measurement gap is used for GNSS measurement.

In an optional implementation, the method further includes: transmitting second indication information, where the second indication information indicates a duration of the GNSS measurement gap.

In an optional implementation, the DCI further indicates to enable the GNSS measurement gap.

In an optional implementation, the method further includes: transmitting third indication information, where the third indication information indicates a duration of a timer corresponding to a GNSS measurement result.

In an optional implementation, the method further includes: receiving timing reference indication information, where the timing reference indication information indicates a reference valid duration of the GNSS measurement result; and determining the duration of the timer according to the reference valid duration.

In an optional implementation, a location of the GNSS measurement gap is prior to a time-domain resource location of the data, or the time-domain resource location of the data is prior to the location of the GNSS measurement gap.

In an optional implementation, a start location of the time-domain resource of the data relies on an end location of the GNSS measurement gap and a first delay value, where the first delay value is a delay of the start location of the time-domain resource of the data relative to the end location of the GNSS measurement gap; or the start location of the time-domain resource of the data relies on an end location of the time-domain resource of the DCI and a second delay value, where the second delay value is a delay of the start location of the time-domain resource of the data to the end location of the time-domain resource of the DCI.

According to a third aspect, embodiments of the disclosure further provides another measurement method. The method includes: determining downlink control information (DCI); and transmitting the DCI, where the DCI is used to trigger a random access procedure or the DCI is used to schedule data; where the DCI is further used to indicate to enable a global navigation satellite system (GNSS) measurement gap, and the GNSS measurement gap is used for GNSS measurement.

In an optional implementation, before transmitting the DCI, the method further includes: transmitting first indication information, where the first indication information indicates a time offset, where the time offset is a duration between the GNSS measurement gap and a time-domain resource of the DCI, and the DCI is used to trigger a random access procedure or the DCI is used to schedule the data; or the time offset is a duration between the GNSS measurement gap and a time-domain resource of the data and the DCI is used to schedule the data.

In an optional implementation, the method further includes: transmitting second indication information, where the second indication information indicates a duration of the GNSS measurement gap.

In an optional implementation, the method further includes: transmitting third indication information, where the third indication information indicates a duration of a timer corresponding to a GNSS measurement result.

In an optional implementation, the method further includes: receiving timing reference indication information, where the timing reference indication information indicates a reference valid duration of the GNSS measurement result; and determining the duration of the timer according to the reference valid duration.

In an optional implementation, a location of the GNSS measurement gap is prior to a time-domain resource location of the data, or the time-domain resource location of the data is prior to the location of the GNSS measurement gap.

In an optional implementation, a start location of a time-domain resource of the data relies on an end location of the GNSS measurement gap and a first delay value, where the first delay value is a delay of the start location of the time-domain resource of the data relative to the end location of the GNSS measurement gap; or the start location of the time-domain resource of the data relies on an end location of a time-domain resource of the DCI and a second delay value, where the second delay value is a delay of the start location of the time-domain resource of the data to the end location of the time-domain resource of the DCI.

According to a fourth aspect, embodiments of the disclosure provide a communication device. The communication device includes units for implementing the method of the first aspect, the second aspect, or the third aspect.

According to a fifth aspect, embodiments of the disclosure provides another communication device. The communication device includes a processor. The processor is configured to perform the method of the first aspect, the second aspect, or the third aspect.

In an optional implementation, the communication device may further include a memory. The memory is configured to store a computer program. The processor is configured to invoke the computer program from the memory, to perform the method of the first aspect, the second aspect, or the third aspect.

According to a sixth aspect, embodiments of the disclosure provides a chip. The chip is configured to perform the method of the first aspect, the second aspect, or the third aspect.

According to a seventh aspect, embodiments of the disclosure provides a chip module. The chip module includes a communication interface and a chip. The communication interface is used for communication within the chip module or for communication between the chip module and an external device. The chip is used to perform the method of the first aspect, the second aspect, or the third aspect.

According to an eighth aspect, embodiments of the disclosure provide a computer-readable storage medium. The computer-readable storage medium stores a computer program including program instructions. When executed by a communication device, the program instructions cause the communication device to perform the method of the first aspect, the second aspect, or the third aspect.

In a ninth aspect, embodiments of the disclosure provide a computer program product. The computer program product includes a computer program or instructions. When run on a computer, the computer program or instructions cause the computer to perform the method of the first aspect, the second aspect, or the third aspect.

In embodiments of the disclosure, the location of the GNSS measurement gap is determined according to the time-domain resource location of the DCI or the time-domain resource location of the data scheduled by the DCI, so the location of the GNSS measurement gap can be flexibly determined.

Each module/unit included in each device or product described in the above-described embodiment may be a software module/unit, a hardware module/unit, or may be partly a software module/unit, or partly a hardware module/unit. For example, for each device or product applied to or integrated into a chip, each module/unit included therein may be implemented in hardware such as circuits; or at least some modules/units may be implemented in a software program running on a processor integrated within the chip and the remaining (if any) modules/units can be implemented by hardware such as circuits. For each device or product applied to or integrated into a chip module, each module/unit included therein may be implemented in hardware such as circuits, and different modules/units may be located in the same component (e.g., chip, circuit module, etc.) or different components of the chip module; or at least some modules/units may be implemented in a software program running on an integrated processor within the chip module and the remaining (if any) modules/units can be implemented by hardware such as circuits. For each device or product applied to or integrated into a terminal, each module/unit included therein may be implemented in hardware such as circuits, and different modules/units may be located in the same component (e.g., chip, circuit module, etc.) or in different components of the terminal; or at least some modules/units may be implemented in a software program running on an integrated processor in the terminal and the remaining (if any) part of the modules/units may be implemented in hardware such as circuits.

It should be noted that each of the above-described method embodiments is expressed as a series of combinations of operations for the sake of simplicity of description. Those skilled in the art should know that the disclosure is not limited by the described sequence of operations, because some steps may be performed in other sequences or simultaneously according to the disclosure. Furthermore, those skilled in the art should also understand that the embodiments described in the specification are preferred embodiments, and the actions and modules involved are not necessarily necessary for the disclosure.

The steps in the methods of the embodiments of the disclosure can be adjusted in order, merged, and deleted according to actual needs.

The modules in the device of the embodiments of the disclosure may be merged, divided, and deleted according to actual needs.

One of ordinary skill in the art will appreciate that all or part of the steps in the various methods of the above-described embodiments may be accomplished by program instructions and related hardware. The program instructions may be stored in a computer-readable storage medium, and the computer-readable storage medium may include a flash disk, a ROM, a RAM, a magnetic disk or an optical disk, or the like.

The foregoing disclosure is only one embodiment of the disclosure, and is merely a part of embodiments of the disclosure, which does not limit the scope of the disclosure.

1. A measurement method, comprising:
receiving downlink control information (DCI); and
determining a location of a global navigation satellite system (GNSS) measurement gap at least according to a time-domain resource location of the DCI, wherein the DCI is used to trigger a random access procedure or the DCI is used to schedule data; or determining the location of the GNSS measurement gap at least according to a time-domain resource location of data, wherein the DCI is used to schedule the data, wherein
the GNSS measurement gap is used for GNSS measurement.

2. The method of claim 1, wherein determining the location of the GNSS measurement gap at least according to the time-domain resource location of the DCI comprises:
determining the location of the GNSS measurement gap according to the time-domain resource location of the DCI and a time offset, wherein the time offset is a duration between the GNSS measurement gap and a time-domain resource of the DCI.

3. The method of claim 1, wherein determining the location of the GNSS measurement gap at least according to the time-domain resource location of the data comprises:
determining the location of the GNSS measurement gap according to the time-domain resource location of the data and a time offset, wherein
the time offset is a duration between the GNSS measurement gap and a time-domain resource of the data.

4. The method of claim 2, wherein before receiving the DCI, the method further comprises:
receiving first indication information, wherein the first indication information indicates the time offset.

5. The method of claim 1, further comprising:
receiving second indication information, wherein the second indication information indicates a duration of the GNSS measurement gap.

6. (canceled)

7. (canceled)

8. The method of claim 1, further comprising:
performing GNSS measurement within the GNSS measurement gap if a previous GNSS measurement result fails, wherein the previous GNSS measurement result is obtained from the most recent GNSS measurement.

9. The method of claim 8, wherein failure of the previous GNSS measurement result comprises that: a timer corresponding to the previous GNSS measurement result expires.

10. The method of claim 9, further comprising:
receiving third indication information, wherein the third indication information indicates a duration of the timer.

11. The method of claim 10, further comprising:
transmitting timing reference indication information, wherein the timing reference indication information indicates a reference valid duration of a GNSS measurement result.

12. The method of claim 7, wherein after performing GNSS measurement within the GNSS measurement gap, the method further comprises:
transmitting a physical random access channel (PRACH), wherein the DCI is used to trigger the random access procedure.

13. The method of claim 1, wherein the location of the GNSS measurement gap is prior to the time-domain resource location of the data, or the time-domain resource location of the data is prior to the location of the GNSS measurement gap.

14. The method of claim 13, wherein
a start location of a time-domain resource of the data relies on an end location of the GNSS measurement gap and a first delay value, wherein the first delay value is a delay of the start location of the time-domain resource of the data relative to the end location of the GNSS measurement gap; or
the start location of the time-domain resource of the data relies on an end location of a time-domain resource of the DCI and a second delay value, wherein the second delay value is a delay of the start location of the time-domain resource of the data to the end location of the time-domain resource of the DCI.

15. A measurement method, comprising:
transmitting first indication information, wherein the first indication information indicates a time offset; and
transmitting downlink control information (DCI), wherein
the time offset is a duration between a global navigation satellite system (GNSS) measurement gap and a time-domain resource of the DCI, and the DCI is used to trigger a random access procedure or the DCI is used to schedule data; or the time offset is a duration between the GNSS measurement gap and a time-domain resource of data and the DCI is used to schedule the data; and the GNSS measurement gap is used for GNSS measurement.

16. The method of claim 15, further comprising:
transmitting second indication information, wherein the second indication information indicates a duration of the GNSS measurement gap.

17. The method of claim 15, wherein the DCI further indicates to enable the GNSS measurement gap.

18. The method of claim 15, further comprising:
transmitting third indication information, wherein the third indication information indicates a duration of a timer corresponding to a GNSS measurement result.

19. The method of claim 18, further comprising:
receiving timing reference indication information, wherein the timing reference indication information indicates a reference valid duration of the GNSS measurement result; and
determining the duration of the timer according to the reference valid duration.

20. The method of claim 15, wherein a location of the GNSS measurement gap is prior to a time-domain resource location of the data, or the time-domain resource location of the data is prior to the location of the GNSS measurement gap.

21. The method of claim 20, wherein
a start location of the time-domain resource of the data relies on an end location of the GNSS measurement gap and a first delay value, wherein the first delay value is a delay of the start location of the time-domain resource of the data relative to the end location of the GNSS measurement gap; or
the start location of the time-domain resource of the data relies on an end location of the time-domain resource of the DCI and a second delay value, wherein the second delay value is a delay of the start location of the time-domain resource of the data to the end location of the time-domain resource of the DCI.

22-28. (canceled)

29. A communication device, comprising:
a transceiver;
a memory storing computer programs; and
a processor coupled with the memory and the transceiver and configured to invoke the computer programs to:
cause the transceiver to receive downlink control information (DCI); and
determine a location of a global navigation satellite system (GNSS) measurement gap at least according to a time-domain resource location of the DCI, wherein the DCI is used to trigger a random access procedure or the DCI is used to schedule data; or determine the location of the GNSS measurement gap at least according to a time-domain resource location of data, wherein the DCI is used to schedule the data, wherein
the GNSS measurement gap is used for GNSS measurement.

30.-35. (canceled)
